(19) United States
(12) Patent Application Publication
(10) Pub. No.: US 2011/0156365 A1
(43) Pub. Date: Jun. 30, 2011

(54) LIFT WHEEL SET USED IN A MACHINE TOOL

(75) Inventor: Cheng-Hung CHIU, Taichung (TW)

(73) Assignee: REXON INDUSTRIAL CORP., LTD., Taichung (TW)

(21) Appl. No.: 12/976,172

(22) Filed: Dec. 22, 2010

(30) Foreign Application Priority Data
Dec. 30, 2009 (TW) 098145994

(51) Int. Cl. B60B 33/06; B62B 5/00

(52) U.S. Cl. 280/43.24; 16/32

(57) ABSTRACT

A lift wheel set used in a machine tool includes a mounting member having a first bevel face, a wheel holder having a second bevel face and a wheel. When the wheel holder is in a first position, the second bevel face of the wheel holder is seated with the first bevel face of the mounting plate, and the wheel holder is prohibited from downward movement. When the wheel holder is in the second position, the second bevel face of the wheel holder is slid along and forced against the first bevel face of the mounting member so that the wheel holder is moved downwards relative to the mounting member to force the wheel into engagement with the floor for enabling the machine tool to be moved to a desired location by rotation of the wheel.

This application claims, under 35 U.S.C. §119, priority to Taiwanese Application No. 098145994, filed Dec. 30, 2009, which application is hereby incorporated by reference in its entirety, inclusive of the specification, claims, and drawings.

### FIELD OF THE INVENTION

The present disclosure relates to machine tools and more particularly, to a lift wheel set used in a machine tool. The disclosure relates also to a base frame assembly of a machine tool using a lift wheel set.

### BACKGROUND

Regular floor type machine tools (such as drill presses) are commonly quite large and very heavy, and are not easily movable by an operator. In particular, in order to move a floor type machine tool from one place to another, several persons are typically required to join together and to lift the floor type machine tool above the floor for movement thereof. Thus, a large amount of labor and time are required in order to move a floor type machine tool. Additionally, there is substantial risk of personal injury or machine tool damage that may accidentally occur during movement of the machine tool. Further, to facilitate movement of a machine tool, rollers may be installed in the base frame of the machine tool in order to allow easier movement of the machine tool. However, it is dangerous to operate a machine tool that is equipped with rollers, since such a machine tool does not provide a stable, stationary platform for working on a workpiece.

### SUMMARY

The present disclosure has been accomplished under the circumstances in view. Accordingly, the present disclosure describes an exemplary embodiment of a lift wheel set for use in a machine tool, wherein the operator can safely use the machine tool when the lift wheel set is lifted and maintained above the floor or supporting surface, or can conveniently move the machine tool from one position to another with less effort when the lift wheel set is lowered into contact with the floor or supporting surface.

To achieve this and other objects of the present disclosure, a lift wheel set includes a mounting member, a wheel holder, and a wheel. The mounting member includes at least one first beveled face. The wheel holder has a rotating member and a support member pivotally connected to the rotating member. The rotating member includes at least one second beveled face. Further, the rotating member is connected to the mounting member and is rotatable relative to the mounting member between a first position and a second position. The wheel is rotatably mounted in the support member.

When the rotating member is in the first position, the at least one second beveled face of the rotating member is respectively corresponds to the at least one first beveled face of the mounting member, and the wheel holder is prevented from having any downward movement relative to the mounting member. At this time, the wheel is spaced away from the floor or supporting surface. When rotating member is rotated from the first position to the second position, the at least one second beveled face of the rotating member respectively cooperatively engages the at least one first beveled face of the mounting member, causing the wheel holder to be lowered relative to the mounting member in order to move the wheel into contact with the floor or supporting surface. Thus, by means of rotating the wheel along the floor or supporting surface, the operator can safely and conveniently move the machine tool to a desired position with less effort.

Further, the rotating member includes a handle extending through an elongated slot on a base frame of the machine tool away from the machine tool for manipulation by an externally applied force to move the rotating member between the first position and the second position in order to adjust the height of the wheel between a position spaced from a supporting surface and a position in contact with the supporting surface.

### BRIEF DESCRIPTION OF THE DRAWINGS

FIG. 1 is an exploded view of a lift wheel set in accordance with the present disclosure.

FIG. 2 is an applied view of the present disclosure, illustrating multiple lift wheel sets installed in a machine tool.

FIG. 3 is a schematic sectional view of the handle and rotating member of the present disclosure, illustrating the rotating member in the first position.

FIG. 4 is a schematic sectional side view of the present disclosure, illustrating the wheel holder and the wheel retained spaced from and positioned above the floor.

FIG. 5 corresponds to FIG. 3, illustrating the rotating member in the second position.

FIG. 6 corresponds to FIG. 4, illustrating the wheel holder lowered and the wheel maintained in contact with the floor.

### DETAILED DESCRIPTION

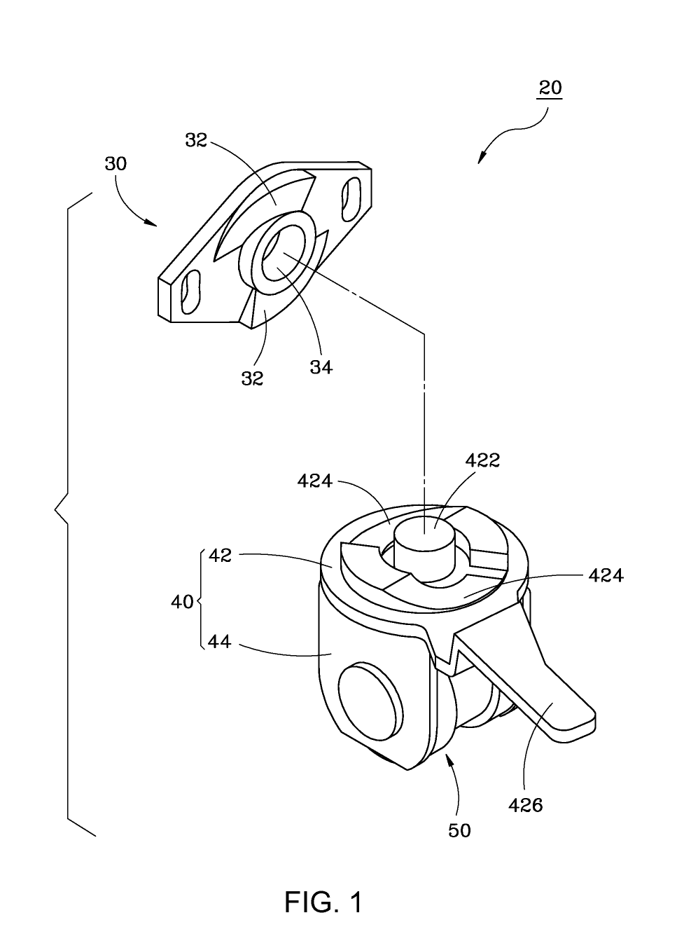

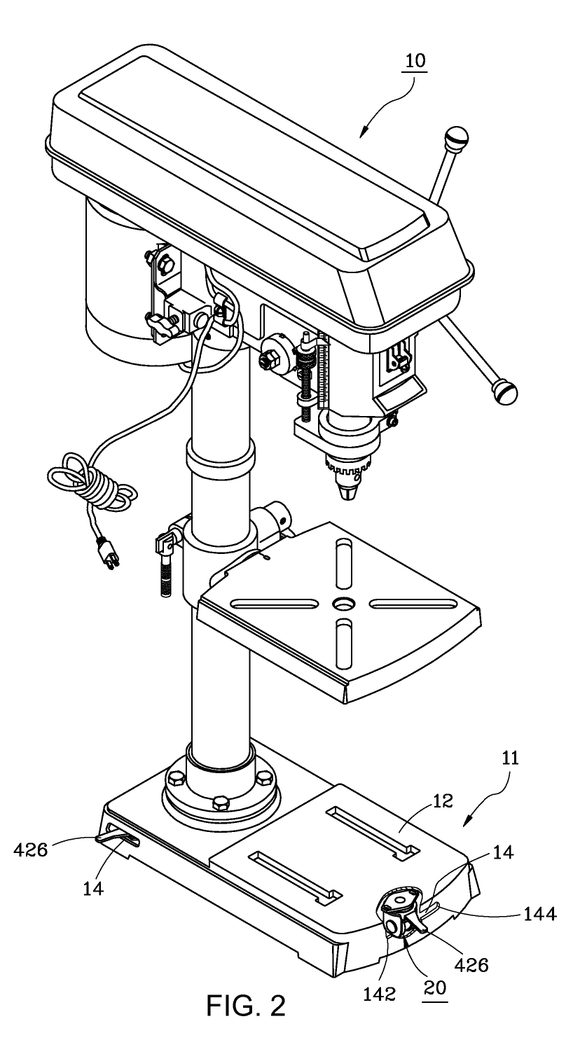

Referring to FIG. 1, a lift wheel set 20 in accordance with the present disclosure is shown including a mounting member 30, a wheel holder 40, and a wheel 50.

The mounting member 30 has two first beveled faces 32 and a pivot hole 34 disposed between the two first beveled faces 32 and passing through the mounting member 30.

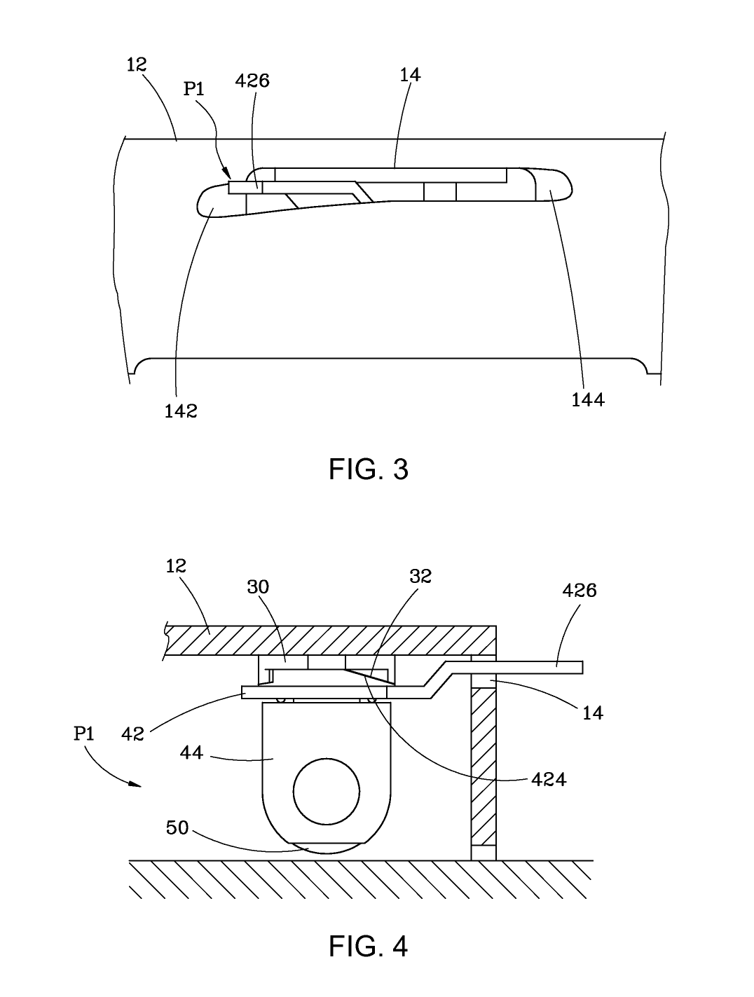

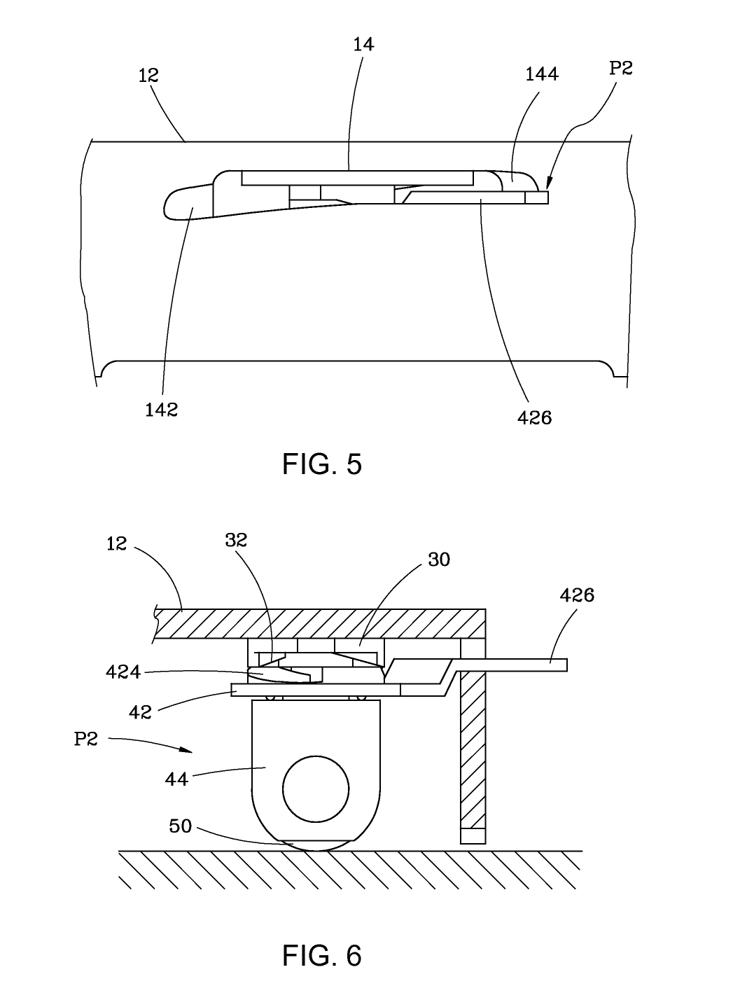

The wheel holder 40 includes a rotating member 42 and a support member 44. The rotating member 42 has a pivot pin 422, two second beveled faces 424, and a handle 426. The pivot pin 422 is inserted through the pivot hole 34 and is thus pivotally connected to the mounting member 30, thus allowing rotation of the rotating member 42 relative to the mounting member 30 between a first position P1 and a second position P2, as shown in FIG. 3 and FIG. 5.

The sloping direction of the two second beveled faces 424 is complementary and reversed to the sloping direction of the two first beveled faces 32. When the rotating member 42 is in the first position P1, the two second beveled faces 424 of the rotating member 42 are respectively seated with the two first beveled faces 32 of the mounting member 30, as shown in FIG. 4.

When the rotating member 42 is rotated to the second position P2, the two second beveled faces 424 of the rotating member 42 respectively slide along and against the two first beveled faces 32 of the mounting member 30, until the rotating member 42 is situated in the second position P2 as shown in FIG. 6. Additionally, the contact area between the two second beveled faces 424 of the rotating member 42 and the two first beveled faces 32 of the mounting member 30 when the rotating member 42 is in the first position P1 is greater than that when the rotating member 42 is in the second position P2.

The handle 426 can be manipulated by an externally applied force to rotate the rotating member 42 between the first position P1 and the second position P2. The support member 44 is pivotally mounted on the bottom side of the rotating member 42 to pivotally support the wheel 50 thereon.

After description of the structural features of the lift wheel set, an exemplary application of the lift wheel set 20, and the complementary matching and relative functioning between the mounting member 30 and the wheel holder 40 are outlined hereinafter.

During installation of the lift wheel set 20, the mounting member 30 is affixed to the bottom wall of a base frame 12 of a machine tool 10 so that the base frame 12 and the mounting member 30 constitute a base frame assembly 11. At this time, the handle 426 of the rotating member 40 is inserted through an elongated slot 14 on one sidewall of the base frame 12. The elongated slot 14 has a first end 142 and an opposed second end 144. Further, the bottom edge of the elongated slot 14 extends obliquely upwards in direction from the left side toward the right side.

When an operator wishes to move the machine tool 10, the operator moves the handle 426 of the rotating member 42 from the first end 142 of the elongated slot 14 to the second end 144 to rotate the rotating member 42 from the first position P1 shown in FIG. 3 to the second position P2 shown in FIG. 5. At this time, the handle 426 of the rotating member 42 is positioned and stopped at the second end 144 of the elongated slot 14 and further frictionally engages the bottom edge of the elongated slot 14, and therefore the handle 426 is locked, i.e., the rotating member 42 is locked in the second position P2.

Further, when the rotating member 42 is rotated from the first position P1 to the second position P2, the two second beveled faces 424 of the rotating member 42 respectively slide and are pushed against the two first beveled faces 32 of the mounting member 30, causing the wheel holder 40 to be lowered relative to the mounting member 30, as shown in FIG. 6. Therefore, when the rotating member 42 is locked in the second position P2, the wheel 50 is maintained in contact with the floor to support the base frame 12 above the floor. At this time, the operator can safely and conveniently move the machine tool 10 to a desired location with less effort by way of rotation of the wheel 50 of each installed lift wheel set 20 along the floor.

When the machine tool 10 reaches the desired position, the handle 426 of the rotating member 42 is moved from the second end 144 of the elongated slot 14 to the first end 142 of the elongated slot 14 to return the rotating member 42 to the first position P1, enabling the two second beveled faces 424 of the rotating member 42 to be respectively matched and seated with the two first beveled faces 32 of the mounting member 30. At this time, the wheel holder 40 is lifted to its former position to retain the wheel 50 away from the floor, as shown in FIG. 4. At the same time, the base frame 12 is forced by the weight of the machine tool 10 into contact with the floor, and thus the machine tool 10 is firmly positioned on the floor by gravity for safe operation by the operator.

As an alternative design of affixing the mounting member 30 to the bottom wall of the base frame 12 of the machine tool 10, the first beveled faces 32 and the pivot hole 34 can be directly formed in the base frame 12 of the machine tool 10 so that the base frame 12 of the machine tool 10 forms the mounting member 30.

In conclusion, the lift wheel set allows the operator to move the wheel holder upwards or downwards relative to a base frame of a machine tool and to further have the machine tool be firmly positioned on the floor or to become conveniently movable from place to place with less effort, and while assuring a high level of safety during movement of the machine tool.

The present disclosure having been thus described with particular reference to the preferred embodiments thereof, it will be obvious that various changes and modifications may be made therein without departing from the spirit and scope of the present disclosure as defined in the disclosure and the claims.

What is claimed is:

1. A lift wheel set for use in a machine tool, comprising:
a mounting member having at least one first beveled face;
a wheel holder having a rotating member and a support member pivotally connected to said rotating member, said rotating member having at least one second beveled face and being rotatable relative to said mounting member between a first position, where said at least one second beveled face is respectively seated with said at least one first beveled face to stop said wheel holder from being moved downwardly relative to said mounting member, and a second position where said at least one second beveled face is respectively slid along and pushed against said at least one first beveled face to lower said wheel holder relative to said mounting member; and
a wheel rotatably mounted in said support member of said wheel holder and movable up and down with said wheel holder relative to said mounting member.

2. The lift wheel set according to claim 1, wherein said rotating member of said wheel holder comprises a handle;
wherein the handle can be manipulated by an externally applied force to rotate said rotating member between said first position and said second position.

3. The lift wheel set according to claim 2, wherein said rotating member comprises a pivot pin having top and bottom ends thereof respectively pivotally connected to said mounting member and said support member.

4. The lift wheel set according to claim 1, comprising two first beveled faces on said mounting member; and two second beveled faces on said rotating member.

5. The lift wheel set according to claim 1, wherein a contact area between said at least one second beveled face of said rotating member and said at least one first beveled face of said mounting member when said rotating member is in said first position is greater than a contact area between said at least one second beveled face of said rotating member and said at least one first beveled face of said mounting member when said rotating member is in said second position.

6. A base frame assembly carrying at least one lift wheel set according to claim 1, comprising:
a base frame having an elongated slot; and
at least one lift wheel set comprising:
a mounting member, a wheel holder and a wheel, said mounting member being fixedly mounted on a bottom side of said base frame, and having at least one beveled face, said wheel holder having a rotating member and a support member pivotally connected to said rotating member, said rotating member having at least one second beveled face and a handle, and being rotatable relative to said mounting member between a first position, where said at least one second beveled face is respectively seated with said at least one first beveled face to stop said wheel holder from being moved downwardly relative to said mounting member, and a second position where said at least one second beveled face is respectively slid along and pushed against said at least one first beveled face to lower said wheel holder relative to said mounting member, said handle extending away from said base frame through said elongated slot;
wherein the handle can be manipulated by an external force to rotate said rotating member between said first position and said second position, said wheel pivotally mounted in said support member of said wheel holder and movable up and down with said wheel holder relative to said mounting member.

7. The base frame assembly according to claim 6, wherein said elongated slot has a first end and a second end; said handle is positioned at said first end of said elongated slot when said rotating member is in said first position; and said handle is positioned at said second end of said elongated slot when said rotating member is in said second position.

8. The base frame assembly according to claim 6, wherein said rotating member comprises a pivot pin having top and bottom ends thereof respectively pivotally connected to said mounting member and said support member.

9. The base frame assembly according to claim 6, comprising two first beveled faces on said mounting member; and two second beveled faces on said rotating member.

10. The base frame assembly according to claim 6, wherein a contact area between said at least one second beveled face of said rotating member and said at least one first beveled face of said mounting member when said rotating member is in said first position is greater than a contact area between said at least one second beveled face of said rotating member and said at least one first beveled face of said mounting member when said rotating member is in said second position.

11. The base frame assembly according to claim 6, comprising two lift wheel sets.

12. The base frame assembly according to claim 7, wherein a bottom edge of the elongated slot extends obliquely upwards in direction from the first end of the slot toward the second end of the slot, such that when the handle of the rotating member is positioned at the second end of the slot, the handle frictionally engages the bottom edge of the slot to lock the handle in position.
